(19) United States
(12) Patent Application Publication
(10) Pub. No.: US 2010/0123668 A1
(43) Pub. Date: May 20, 2010

(54) INTERACTIVE AND PROGRAMMABLE MEDIA SIGN AND GRAPHICAL USER INTERFACE FOR CASINO GAMES

(76) Inventors: Michael J. Kuhn, Spokane, WA (US); Tyler V. Kuhn, Spokane, WA (US); Nathan J. Chatellier, Spokane, WA (US); David A. Krise, Spokane, WA (US)

Correspondence Address: DigiDeal Corporation, 5123 East Third Street, Spokane, WA, 99212, US

(21) Appl. No.: 12/353,262

(22) Filed: Jan. 14, 2009

Related U.S. Application Data
(60) Provisional application No. 61/115,544, filed on Nov. 18, 2008.

(51) Int. Cl. G06F 3/041

(52) U.S. Cl. 345/173

(57) ABSTRACT

An interactive and programmable media sign and graphical user interface for casino games is described. In one implementation, the media sign provides displayable content, such as a game logo, casino banner, and betting limits that can be edited through the same touch screen display that provides the display surface. The media sign recognizes touch gestures to extend a graphical user interface (GUI) for secure entry into an editing mode. Once a user is authenticated, the media sign extends a hierarchy of logically linked GUI pages for editing displayable content and display settings, including importing content. In its multiple display panes, the media sign can present, for example, text, images, slideshows, video, and commercial broadcasts. In one implementation, a current profile of displayable content and display settings can be exported to other media signs, so that a single operator can edit information at one media sign and automatically propagate the edits to numerous media signs in a casino.

### RELATED APPLICATIONS

This patent application claims priority to U.S. Provisional Patent Application No. 61/115,544 to Krise et al., entitled, “Interactive and programmable media sign and graphical user interface for casino games,” filed Nov. 18, 2008 and incorporated herein by reference.

### BACKGROUND

In many casinos and gaming establishments, visual information displays include candles, progressive jackpot meters, and signage attached to table games and sometimes slot machines. Sometimes the conventional signage consists of a fixed, non-electronic display with numbers that can be changed manually. Such signs are often front lit or backlit.

Other forms of conventional signage include a hybrid composed of a non-electronic sign and a few elements that have an electronic digital readout, e.g., for remotely changing betting limits. Still other forms of conventional signage include a video display, such as a cathode ray style tube or an LED display that can present content from a remote source.

What is needed is a sign that has sophisticated graphics and video abilities but also self-contained editing tools that allow displayable content to be securely edited on the spot, without needing additional apparatus for the editing interface.

### SUMMARY

An interactive and programmable media sign and graphical user interface for casino games is described. In one implementation, the media sign provides displayable content, such as a game logo, casino banner, and betting limits that can be edited through the same touch screen display that provides the display surface. The media sign recognizes touch gestures to extend a graphical user interface (GUI) for secure entry into an editing mode. Once a user is authenticated, the media sign extends a hierarchy of logically linked GUI pages for editing displayable content and display settings, including importing content. In its multiple display panes, the media sign can present, for example, text, images, slideshows, video, and commercial broadcasts. In one implementation, a current profile of displayable content and display settings can be exported to other media signs, so that a single operator can edit information at one media sign and automatically propagate the edits to numerous media signs in a casino.

This summary section is not intended to give a full description of interactive and programmable media signs with graphical user interfaces for casino games, or to provide a list of features and elements. A detailed description of example embodiments of the electronic gaming system follows.

### BRIEF DESCRIPTION OF THE DRAWINGS

FIG. 1 is a diagram of an example interactive and programmable media sign with graphical user interface for casino games.

FIG. 2 is a block diagram of an example media sign controller.

FIG. 3 is a block diagram of an example electronic game setup including the media sign.

FIG. 4 is a block diagram of networked electronic game tables, including media signs that can communicate with a central server or with each other.

FIG. 5 is a flow diagram of example operations of the media sign.

FIG. 6 is a diagram of an example display layout of the media sign.

FIG. 7 is a diagram of an example security graphical user interface (GUI) for securing access to a hierarchy of editing GUIs.

FIG. 8 is a diagram of an example unsecured operation of the media sign.

FIG. 9 is a diagram of an example top level menu GUI of an editing mode of the media sign.

FIG. 10 is a diagram of an example editing GUI for selecting a type of banner to edit.

FIG. 11 is a diagram of an example editing GUI for modifying a text banner.

FIG. 12 is a diagram of an example editing GUI for modifying a slideshow banner.

FIG. 13 is a diagram of an example file operations GUI for importing images from a data source.

FIG. 14 is a diagram of an example betting limits GUI for modifying display of maximum and minimum betting limits for a casino game.

FIG. 15 is a diagram of an example file operations GUI for exporting a current profile of displayable content and display settings.

FIG. 16 is a diagram of an example file operations GUI for naming an image, video, profile, or data file to export.

FIG. 17 is a diagram of an example file operations GUI for importing display settings, displayable content, or a profile of displayable content and display settings.

FIG. 18 is a diagram of an example media sign display layout; and of logical links between a hierarchy of GUI pages extended by the media sign.

### DETAILED DESCRIPTION

### Overview

This disclosure describes an interactive and programmable media sign and associated graphical user interfaces (GUIs) for displaying and editing casino information and/or game information. The interactive and programmable media sign and GUIs will be referred to herein as a “media sign.” In one implementation, the media sign consists of a self-contained computing device unit with touch screen display. Programming of displayable content is carried out through the touch screen display. Images and video content for display can be uploaded through a port. As a computing device, the media sign includes a processor, memory, and data storage, as well as the touch screen video display. In another implementation, the media sign stores a profile of its displayable content and settings that can be transferred to other instances of the media sign. In yet another implementation, the media sign can be networked with an electronic game or a server to display a wide range of information in an electronic billboard manner, such as game state information, progressive jackpots, advertisements, announcements, schedules, and commercial television.

At a basic level of implementation, in which the media sign functions mostly as a self-contained sign for an individual casino table or game, the media sign can display an animated game logo, e.g., a custom logo or animation, and betting limits for a casino table game. Even as a standalone game table display, the media sign can also act as a promotion display and advertising device for the gaming establishment. The media sign uses its touch screen technology to allow the gaming establishment to access a system of GUIs that have logically related pages to enable a user to program the visuals displayed by the media sign without having to resort to extra user interface devices, such as keyboard and mouse, to program the display. In other words, the media sign displays information and animated graphics and is fully programmable “on its face,” that is, via a user operating the front facing touch screen display without requiring other equipment.

In one implementation, the media sign identifies a specific gesture on the face of the touch screen display to reveal and enable access to a security GUI for entering a secret, such as a key, code, or password. The secret maintains security over the hierarchy of GUI pages that enable editing displayable content. In other words, in one implementation a user must be authenticated to change the programming. The gesture for revealing the security GUI need not itself be secure, and may consist of various finger motions, e.g., a sequence of finger motions along one or more sides of the touch screen display (for a single-touch implementation of the media sign), or a combination of finger contacts and movements (for a multi-touch implementation of the media sign). Once access is gained, the gaming establishment can modify table betting limits and edit message areas to be presented on the display, or import custom graphics, e.g., for a promotional slide show.

In another implementation, the media sign is interactive in real time with an electronic game. That is, the media sign can display game states and other information as the game is played in real time. For example, the media sign can display numbers drawn, cards dealt, card hands, dice rolled, bets wagered, winners and losers, stages of the game, jackpots, etc. In one implementation, the media sign can be programmed to display a progressive jackpot meter between multiple game devices.

In one implementation, a game/movie pane or area of the display presents a custom graphic, logo, video, or animation. For example, a video may be stored and played on continuous loop, or the video may be streamed from an external source. In one implementation, the media sign displays one or more television channels on at least a part of the touch screen area. Thus, game players may watch television and/or videos while playing the casino game, or between rounds.

In one implementation, the programming for a single media sign, which includes displayable content and associated settings, is exportable as a profile, and is ported for propagation to other instances of the media sign, so that the gaming establishment does not have to manually program numerous signs. The sharing of a profile may be achieved over a network connecting multiple media signs, or via a portable data storage drive.

### Example Media Sign

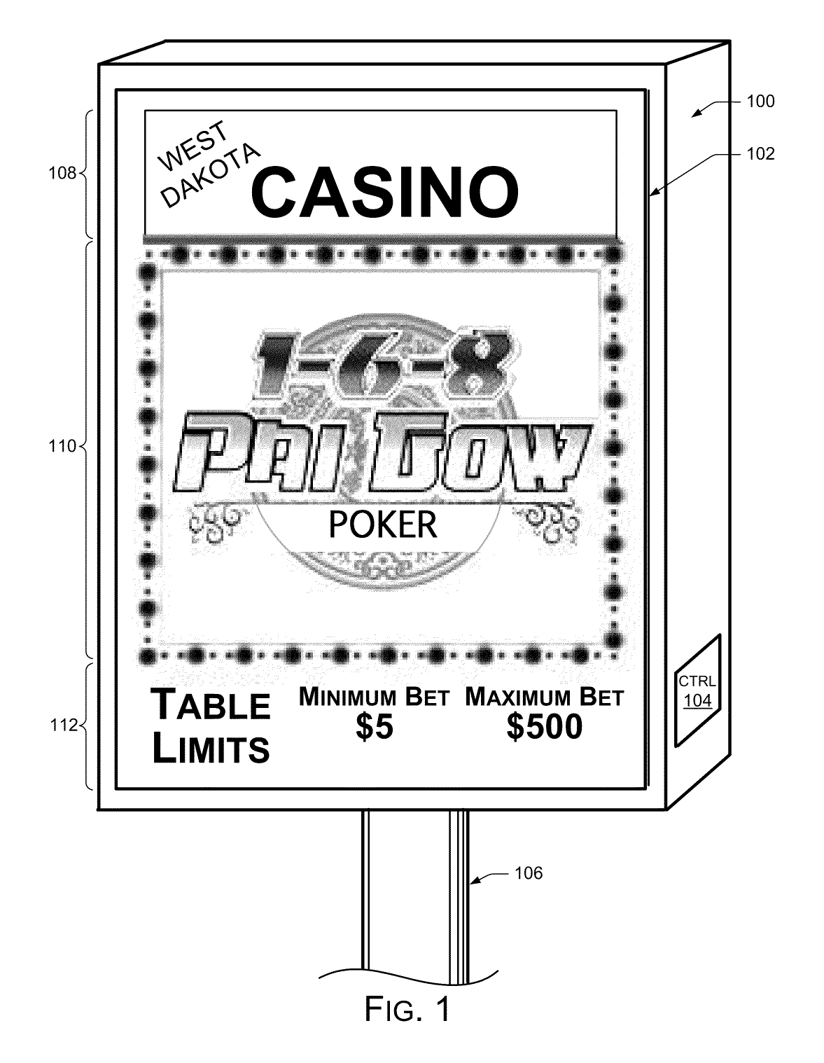

FIG. 1 shows an exemplary media sign 100, which includes a touch screen display 102 and a controller 104. In one implementation, as introduced above, the media sign 100 may constitute a computing device with processor, memory, and data storage. In such a case, elements of the controller 104 can be implemented as software that is stored in the media sign 100 and resides in memory during operation. Or the components and functions to be described below can be committed to hardware, e.g., a controller 104 that is implemented via ASIC chips. The media sign 100 can be mounted at an individual casino game, for example, upon a vertical mount 106 connected to an electronic game table or in some cases, to a slot machine, or even to a wall.

The media sign 100 may have multiple display areas or panes, each with a different function or purpose. For example, a banner 108 may be reserved for information that relates specifically to the casino or establishment in which the media sign 100 is being used. A game/movie pane 110 can be used to display information about the casino game to which the media sign 100 is associated, such as “1-6-8 PAI GOW POKER” as illustrated, or “Blackjack,” “Roulette,” “Craps,” etc. The game/movie pane 110 may be the largest of the designated areas on the touch screen display, and so can be used for presenting video content, i.e., a movie. A betting limits area 112 describes minimum and maximum betting limits for the associated casino game, e.g., table limits.

### Example Systems and Controller

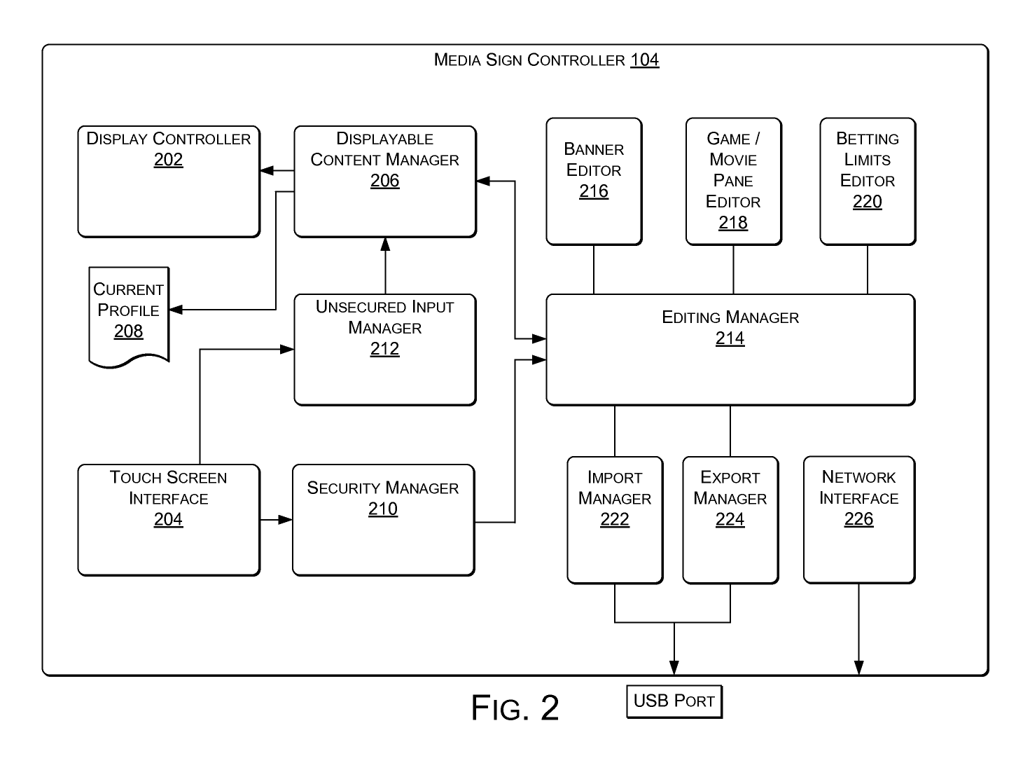

FIG. 2 shows the controller 104 of FIG. 1, in greater detail. The illustrated controller 104 is presented as one example for the sake of description. Other configurations of the controller 104 can also be used in a given implementation of the media sign 100. The exemplary controller 104 can be implemented in hardware, or in combinations of hardware, software, firmware, etc. Some of the illustrated components are built into the typical fabric of a conventional touch screen display 102, but are called out in FIG. 2 in order to show relations between controller components and functions.

The illustrated example controller 104 includes a display controller 202, a touch screen interface 204, a displayable content manager 206, data storage for a current profile 208, a security manager 210, an editing manager 214, a banner editor 216, a game/movie pane editor 218, a betting limits editor 220, an import manager 222, an export manager 224, and a network interface 226.

The display controller 202 drives the display functionality of the touch screen display 102. The touch screen interface 204 accepts touch input from the display surface. A particular touch gesture, such as sliding a finger along multiple edges of the touch screen surface, may cause the security manager 210 to extend a security GUI, which prompts for a key, code, or password before allowing entry into program and content editing. Or, a given touch gesture may be allowed by the unsecured input manager 212, as input to make changes in the content or state of currently displayed content without the security manager 210 having to extend the security GUI. The displayable content manager 206 keeps track of the content currently displayed and the current settings. The displayable content manager 206 stores the content, or links to the content, and the settings in a current profile 208.

Once a user is authenticated via the security manager 210, then the editing manager 214 may extend a hierarchy of editing GUIs. The editing manager 214 coordinates the banner editor 216, game/movie pane editor 218, and betting limits editor 220; as well as the import manager 222 and the export manager 224 to extend a hierarchy of logically linked GUI pages for changing displayable content, including importing and loading images and video clips, changing channel input, and editing text. The import manager 222 and export manager 224 have access to a port, such as a USB port for input/output of data, such as the current profile 208.

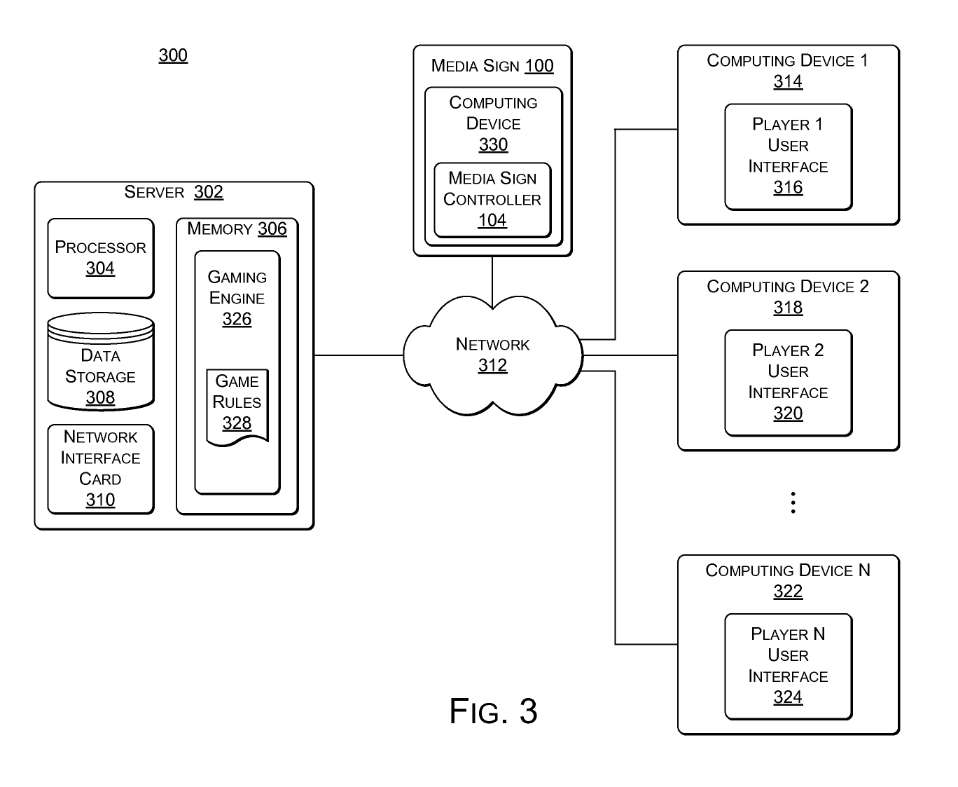

A network interface 226 may communicate with a network interface card (NIC) in versions of the media sign 100 that network with each other; or with an electronic game, the Internet, a remote server, etc. FIG. 3 shows an example electronic game processing system 300 that interacts with the media sign 100. When used in a networked implementation in which an electronic game is also involved, the media sign 100 is a passive recipient of game information for purposes of display only so that the security of the electronic game is not compromised. The illustrated configuration of the example electronic game processing system 300 is meant to provide only one example arrangement for the sake of overview. Many other arrangements of the illustrated components, or similar components, are possible.

The exemplary game processing system 300 includes a server computing device 302, which can be a computer or other device that has processor, memory, and data storage. The illustrated server computing device 302 thus includes a processor 304, memory 306, data storage 308, and an interface, such as a network interface card (NIC) 310, to communicate over a network 312 with remote computing devices, such as computing device “1” 314 that hosts the participant “1” user interface 316; computing device “2” 318 that hosts the participant “2” user interface 320; . . . ; and computing device “N” 322 that hosts the participant “N” user interface 324. The game processing system 300 includes a gaming engine 326 and game rules 328, shown as software loaded into memory 306.

The participant computing devices 314, 318, and 322 may be desktop or notebook computers, or may be workstations or other client computing devices that have processor and memory, but may or may not have onboard data storage. Typically, a player station does not have data storage. Such modules may be “dumb” in that they have no bootable device, but generally receive images and instructions from the server 302. Thus, in one implementation, a player computing device 330 is a visual display with graphics processing power and user interface components.

The media sign 100, which may include its own computing device 330 to host the controller 104, is networked with the server 302 (and the client computing devices) to display a wide range of information from such a game processing system 300, such as game state information, and also other additional information, such as progressive jackpots, advertisements, announcements, schedules, custom images, animation, video; commercial broadcasts, etc.

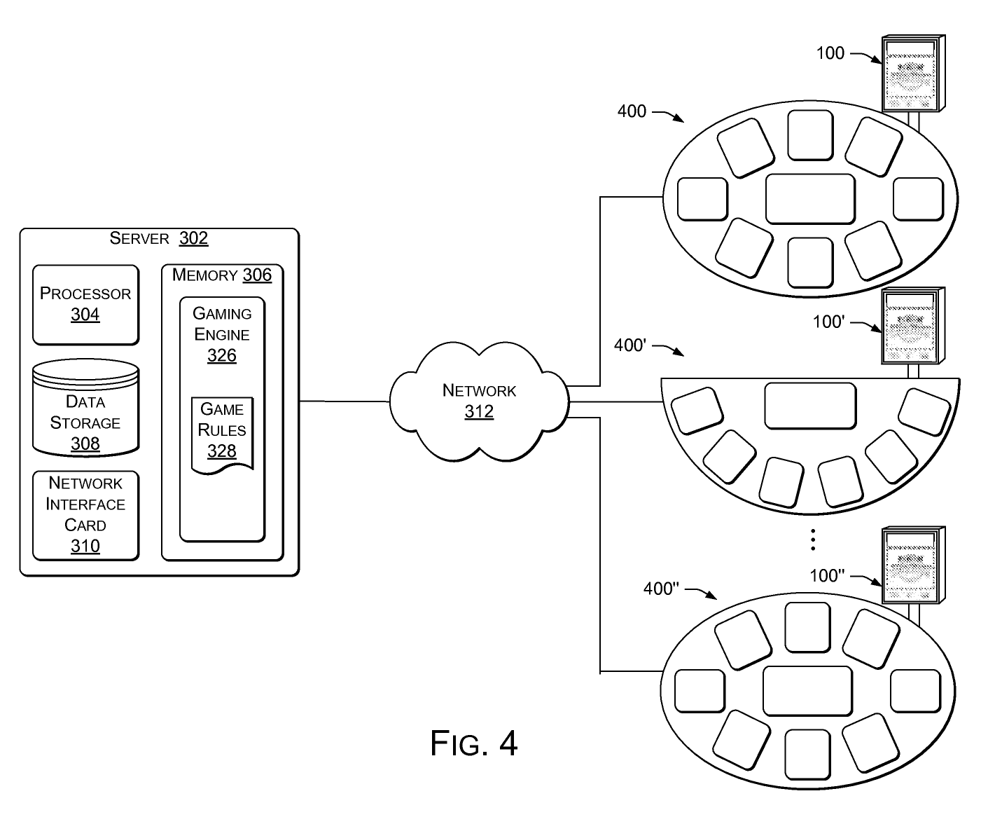

FIG. 4 shows another game processing system, in which instances of the media sign 100, 100′, 100″ are associated with electronic game tables 400, 400′, 400″ and communicate with each other and with a server 302 over a network 312. Each electronic game table 400, 400′, 400″ may have “n” players. Each media sign 100 can communicate with the server 302 to display, as above, a wide range of information, such as game state information, progressive jackpots, advertisements, announcements, schedules, custom images, animation, video; commercial broadcasts, etc. Additionally, the media signs 100, 100′, 100″ can communicate with each other over the network 312. Each media sign 100 can share its current profile 208 with the other media signs, e.g., 100′, 100″. This allows a single technician or operator interacting with the touch screen surface of a single media sign 100 to simultaneously program and/or update the current profiles 208 of numerous media signs 100, such as hundreds of instances of the media sign 100 in a large casino.

### Example Operations and GUIs

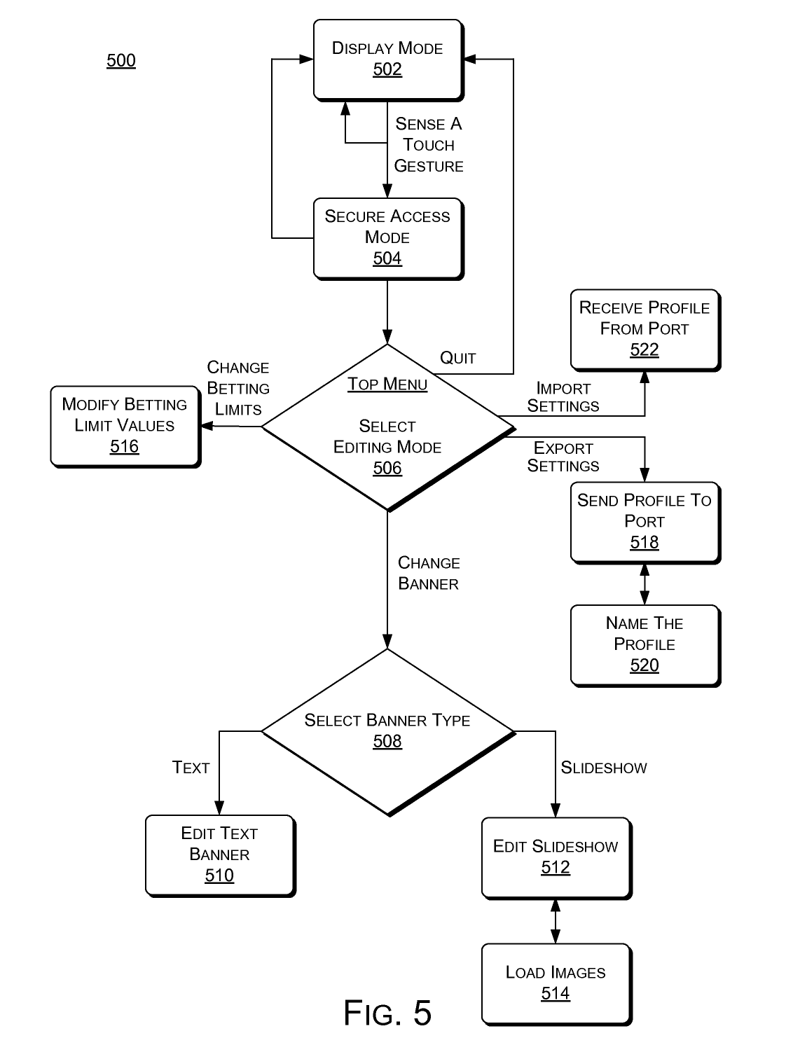

FIG. 5 shows an example process flow 500 between logically linked pages of a GUI hierarchy that can be presented to an operator by the media sign 100. In the flow diagram, operations are summarized in individual blocks. The exemplary process flow 500 may be performed by hardware, or combinations of hardware and software, for example, by components of the exemplary controller 104.

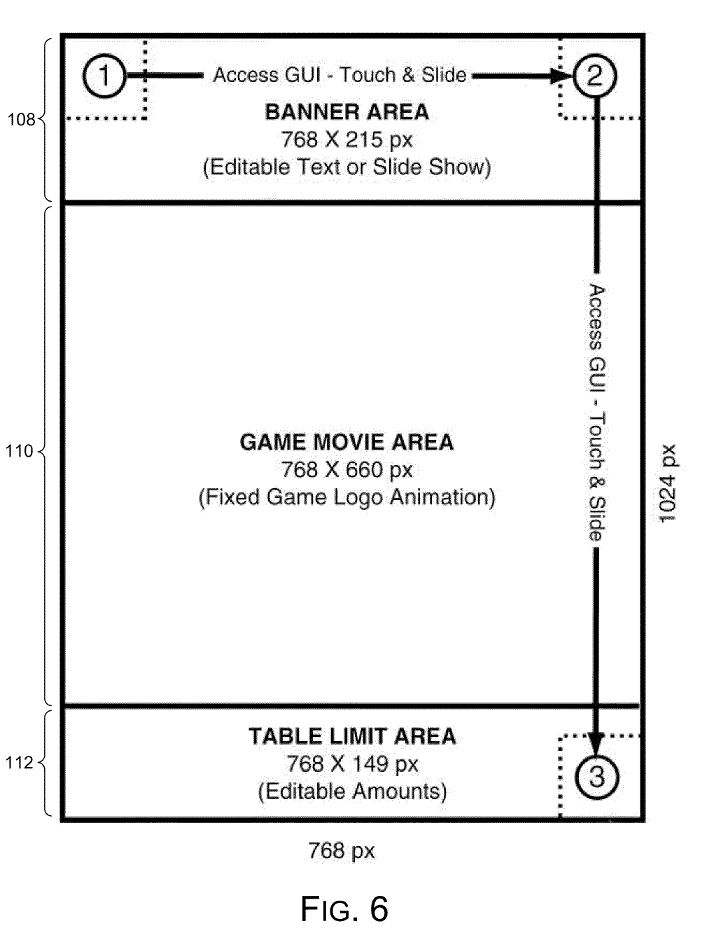

At block 502, the media sign 100 is in a display mode 502. An example display mode 502 is shown in the example display mode layout of FIG. 6, and as shown in the displayed content of FIG. 1, in which the banner 108, the game/movie pane 110, and the betting limits area 112 are being displayed to the public or at least to players and bystanders near the action of a casino game.

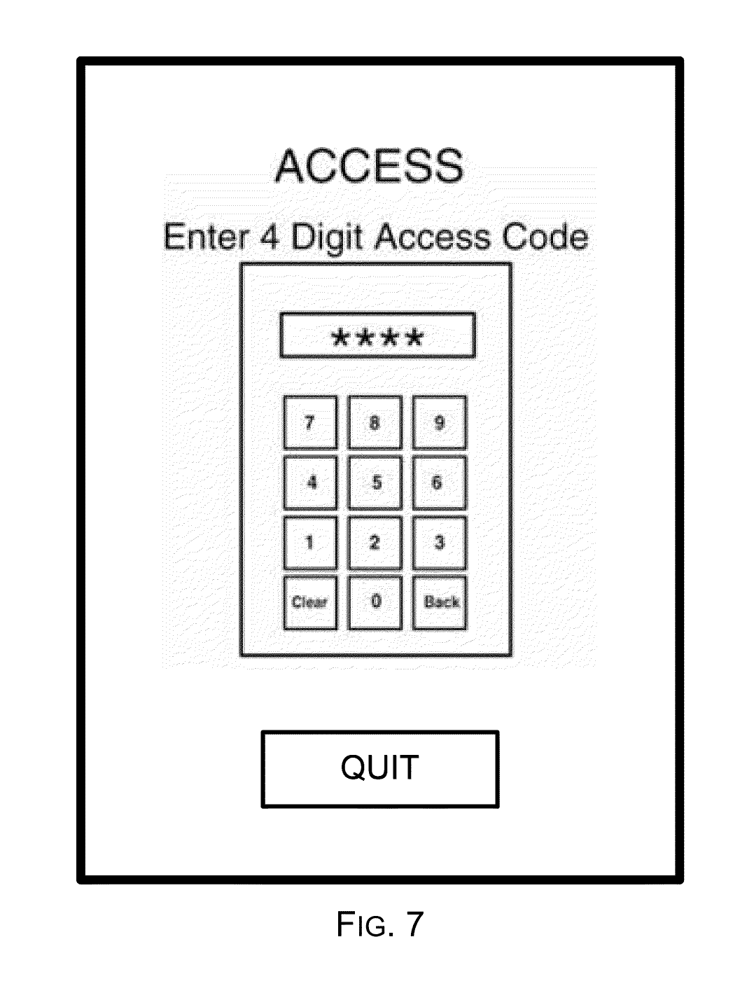

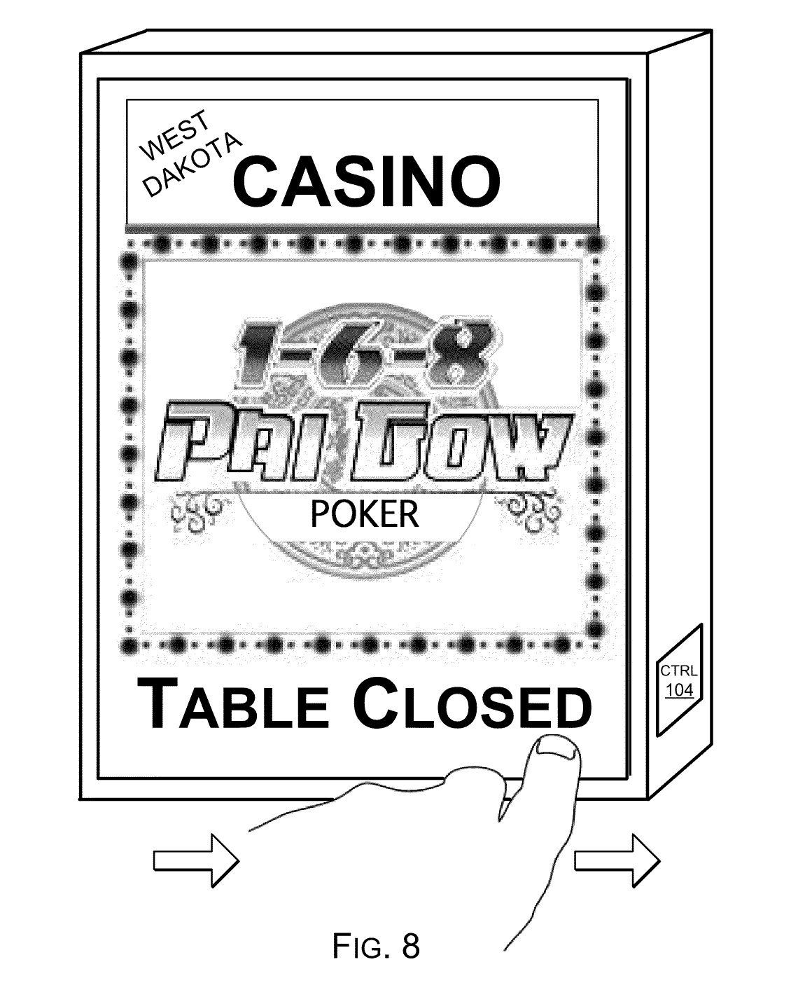

Returning to FIG. 5, at block 504, after sensing a touch gesture on the touch screen display 102 of the media sign 100, the media sign 100 may enter a secure access mode 504, as shown in the example security GUI of FIG. 7, when a touch gesture signals for a program editing menu. Or, the touch gesture may execute an action immediately on the media sign 100 when the touch gesture and associated action are pre-authorized as not needing security clearance to execute the action. An example of an action that can be summoned by a touch gesture and that does not require authorization, is toggling the media sign 100 to turn on and turn off an innocuous message, such as “table closed,” as shown in FIG. 8.

In secure access mode 504, the media sign 100 extends a security GUI (e.g., as in FIG. 7) for inputting a password or other secret information. When authorization is successful, the process flows to a main editing menu, but an option to quit or exit back to display mode 502 is also available.

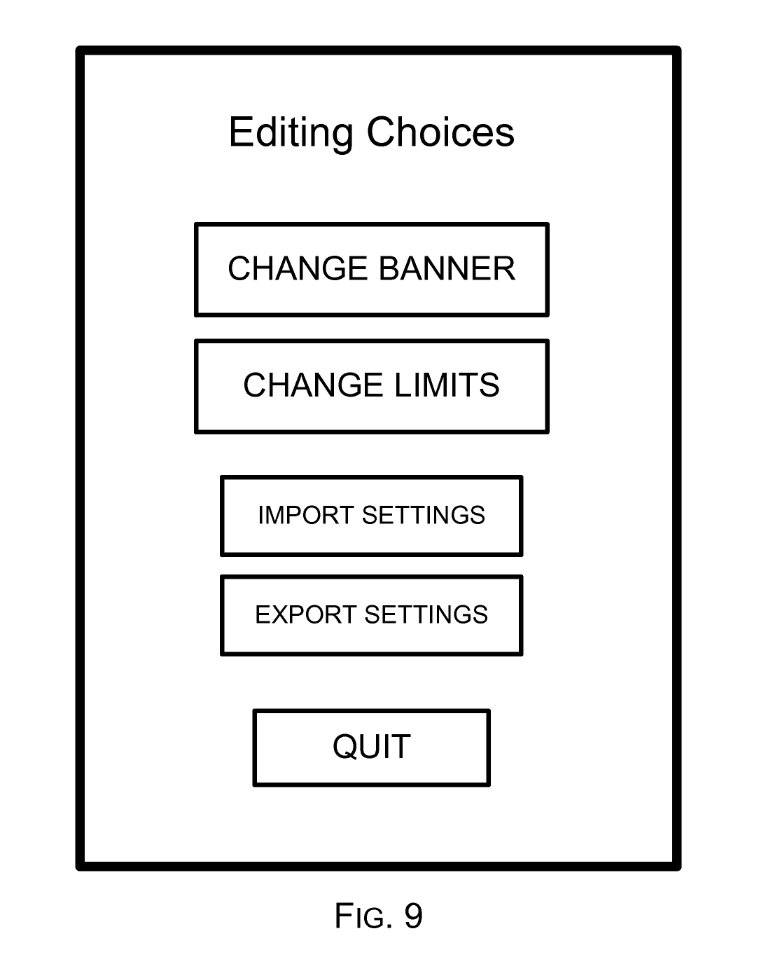

At block 506, the media sign 100 extends a top level menu GUI, such as shown in the example top level editing menu GUI of FIG. 9, which allows the user to select editing modes. For example, the editing modes may include changing betting limits, changing the banner, changing content of the game/movie pane, and importing image content, video content, settings, or an entire profile from another media sign 100, or exporting content and settings to another media sign 100.

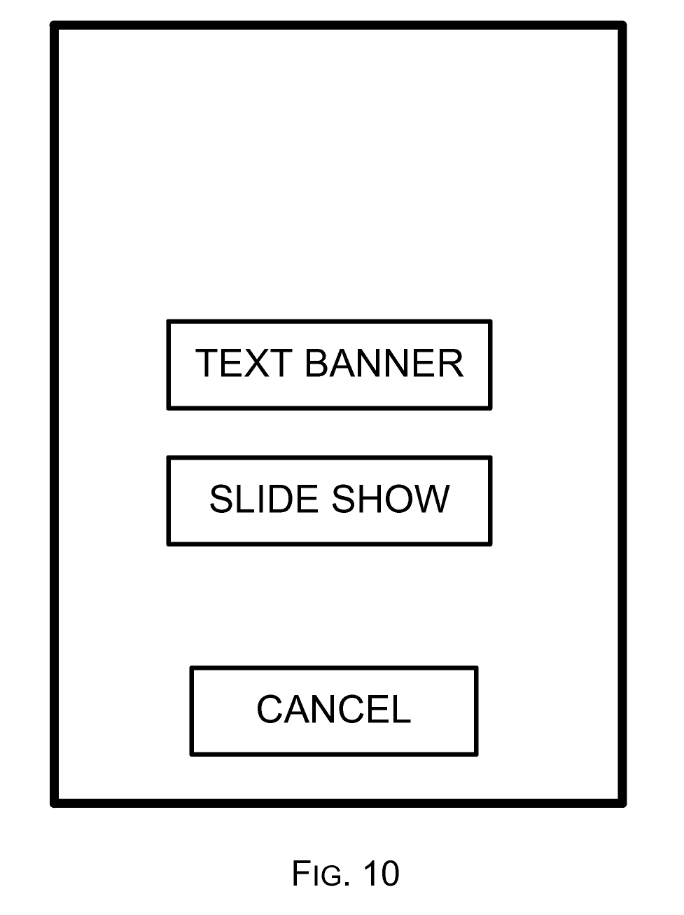

Returning to FIG. 5, at block 508, after selection of a “change banner” mode in the top level editing menu (FIG. 9), the media sign 100 extends a submenu GUI, as shown in FIG. 10, for selecting which type of banner content to edit: a text banner or a slideshow banner.

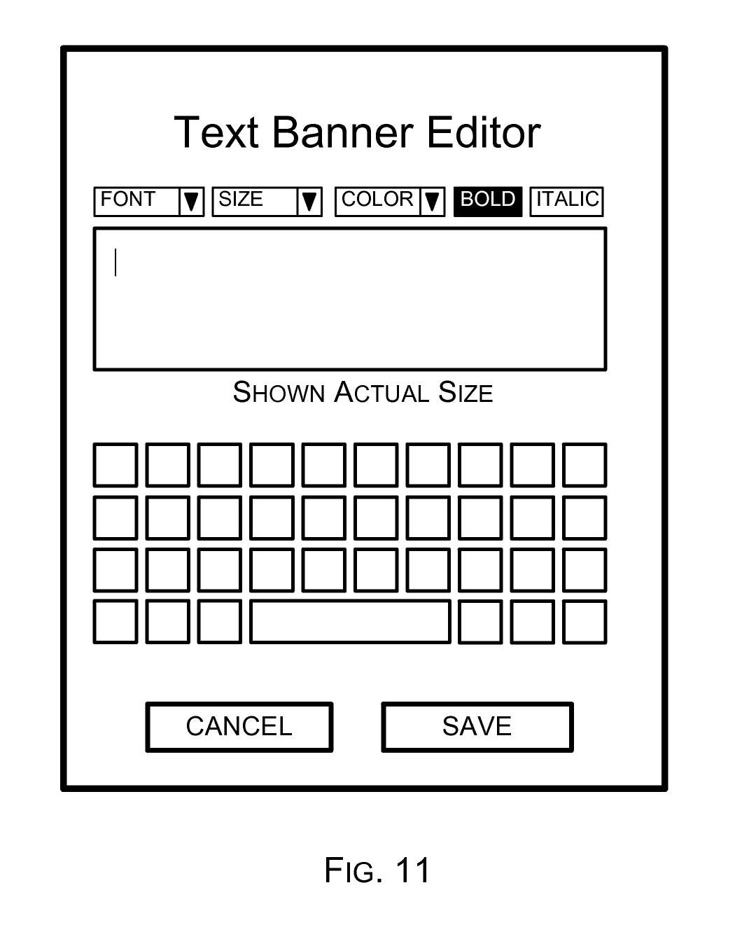

At block 510, if text banner is selected at block 508, the media sign 100 extends a text banner editing GUI, as shown in the example GUI of FIG. 11. The text banner editing GUI may include an onscreen keyboard, navigation controls and icons, and text editing tools for modifying font, color, style, spacing, etc., of text to be used in a banner. The text banner editing GUI may also impart special effects, such a color effects, sparkle effects, moving text, scrolling, rolling, animated text, etc.

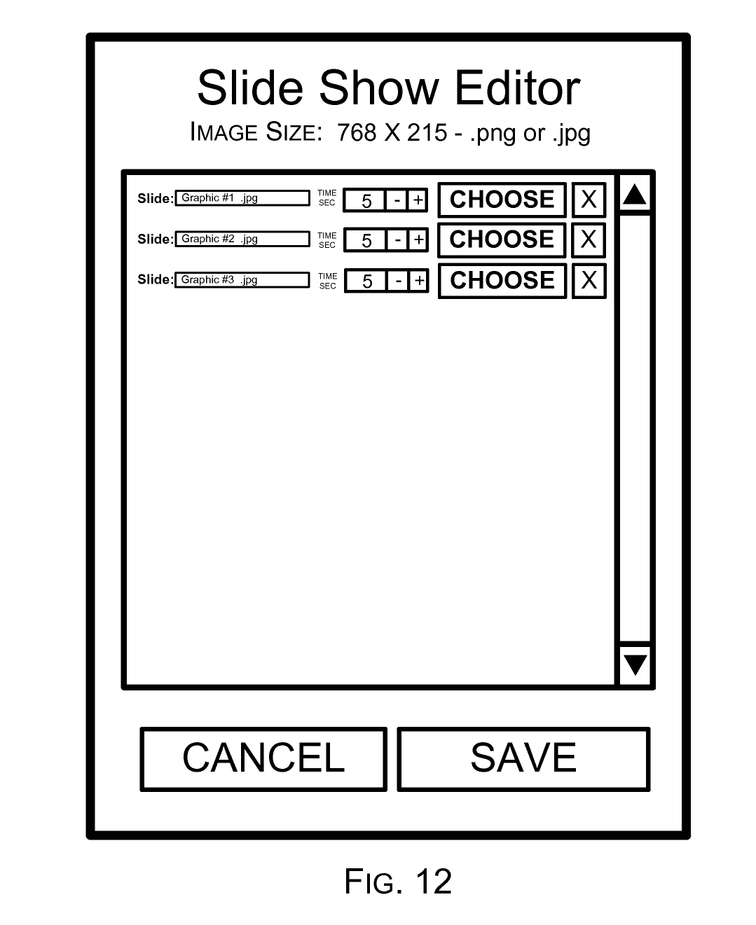

At block 512, if slideshow banner is selected at block 508, the media sign 100 extends a slideshow banner editing GUI, as shown in the example GUI of FIG. 12. The slideshow banner editing GUI may include fields for entering images stored locally to be included in the slideshow to be displayed in the banner, the length of time that each image is to be displayed, and fields for adding and deleting images.

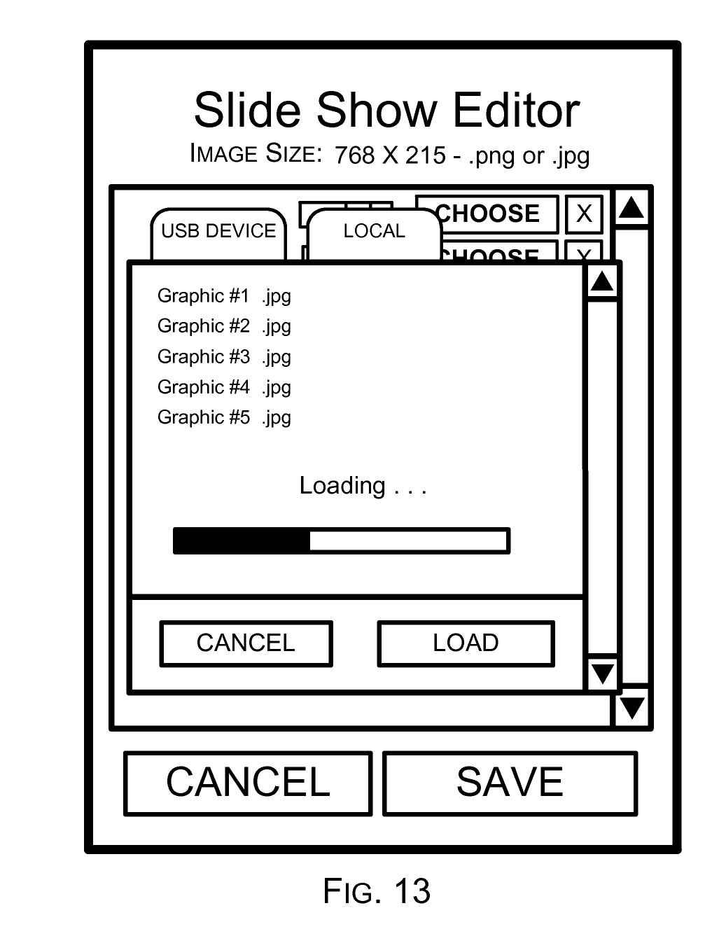

At block 514, upon selection of an appropriate icon or button on the slideshow banner editing GUI (FIG. 12), the media sign 100 extends a file import GUI, as shown in the example GUI of FIG. 13, for loading a selected image file from an external source (or from local data storage) into the slideshow.

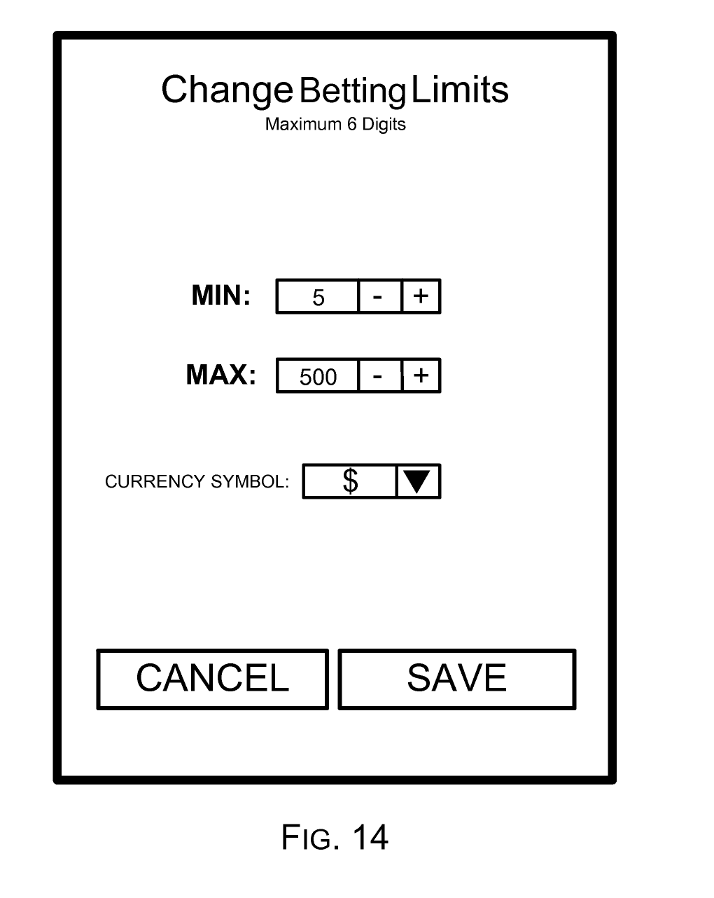

Returning to the top level menu at block 506 of FIG. 5, if the user selects a change betting limits mode, then at block 516 the media sign 100 extends a GUI for modifying betting limits, such as the example GUI shown in FIG. 14. The betting limits editing GUI allows the operator to change minimum and maximum betting limits, usually in integral units of the selected currency.

Likewise, as described above, similar editing GUIs for changing content and settings of the game/movie pane 110 are generally included in the flow of program operations, but not shown in FIG. 5.

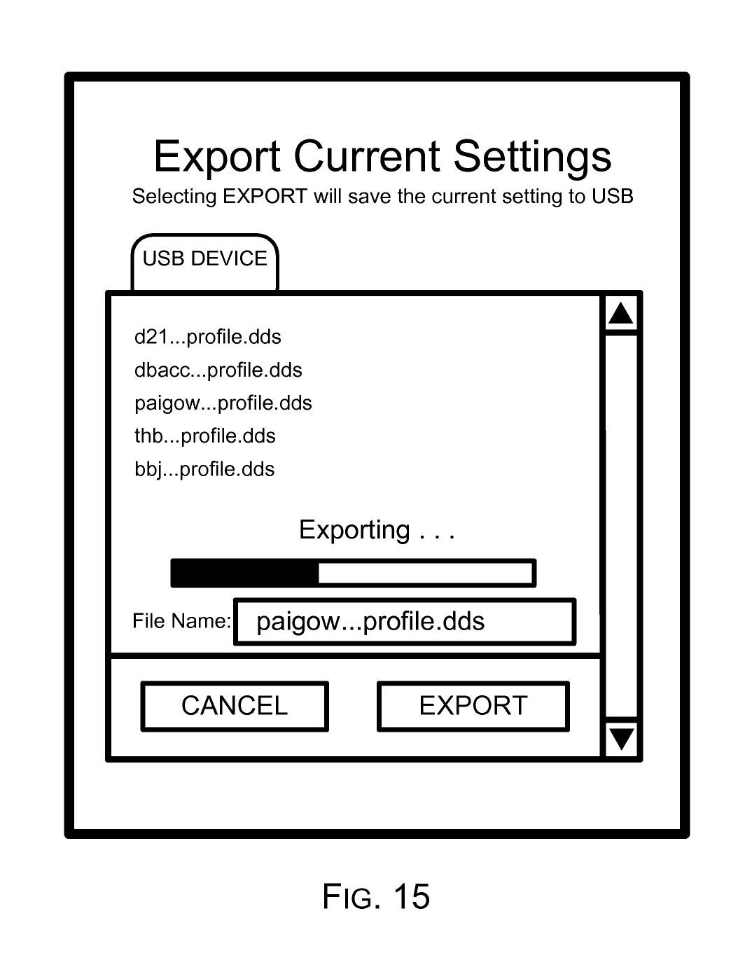

At block 518, given selection by the user of an export option on the top level editing menu (FIG. 9), the media sign 100 extends an export GUI, such as the example GUI shown in FIG. 15. The export GUI may enable the user to export current settings and/or content as a file, that is, as a data file that includes the current profile 208. The GUI may enable export to a USB port, a network interface 226, or to other connected ports when a computing device 330 is included in the media sign 100.

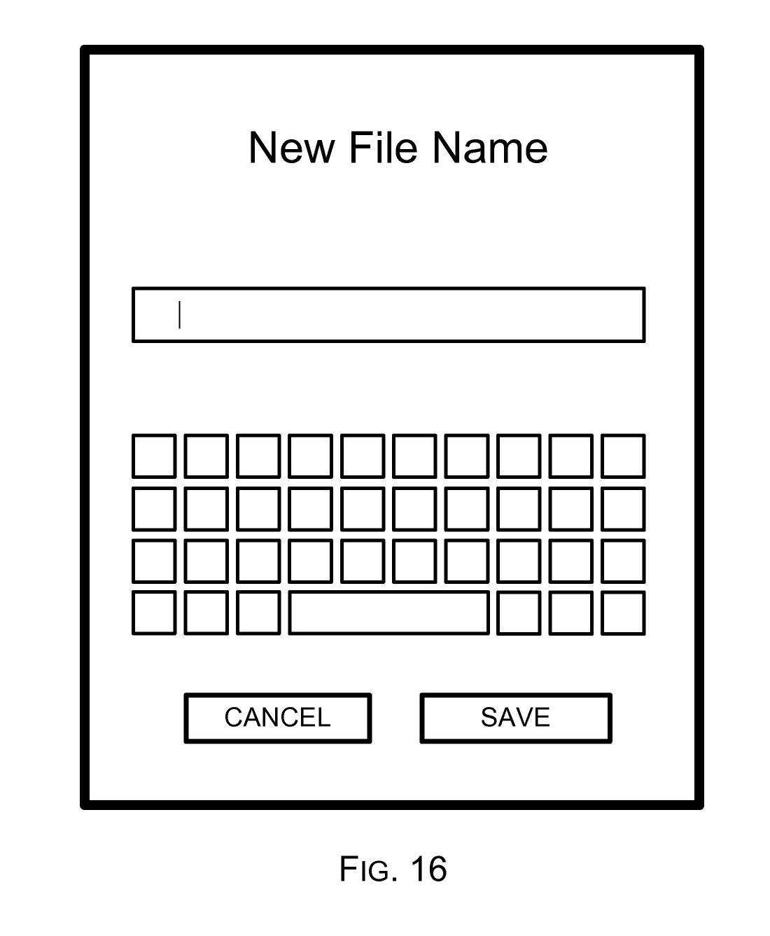

At block 520, if the user desires to store the current profile 208 as a new file, the media sign 100 extends a file naming GUI, such as the example GUI shown in FIG. 16. The file naming GUI has a field for entering a file name, and an onscreen keyboard for keying-in the file name.

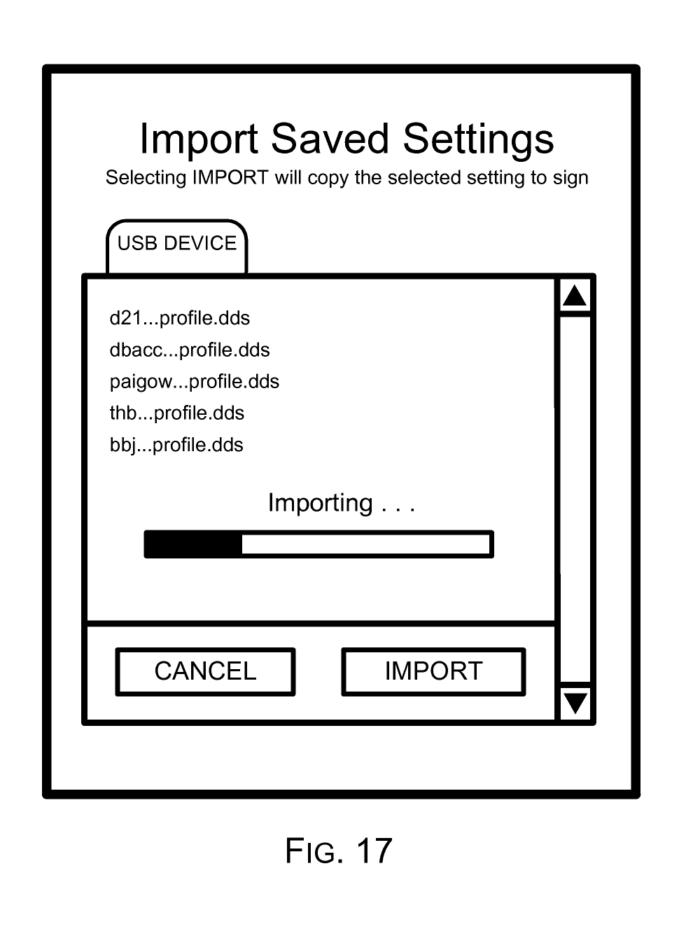

At block 522, given selection by the user of an import option on the top level editing menu (FIG. 9), the media sign 100 extends an import GUI, such as the example GUI shown in FIG. 17. The import GUI allows the operator to manually load (import, download) a current profile 208 that has displayable content, or at least links to displayable content, and settings, such as display settings and visual parameters, from another instance of the media sign 100. The import GUI can allow the operator to load a current profile 208 from a USB port, from a network connection, or from another port as implemented on the particular media sign 100.

In one implementation, as described above, a current profile 208 at one media sign 100 can be automatically sent to other instances of the media sign 100 via a network 312 to automatically update the other media signs 100. This enables editing of a gaming establishment's displayable content at one media sign 100, with automatic propagation of the edits to each of the other media signs 100 in the house.

In one implementation, multiple media signs 100 each have local attributes that can only be edited on the media sign itself, or by authorized remote control, and each media sign 100 also has common attributes that can be updated across multiple media signs 100 by automatic synchronization of a transmitted current profile 208 from another media sign 100. For example, the game/movie pane 110 is generally an area of the display that is reserved for displaying information about the casino game to which the media sign is associated, i.e., about the actual game table to which the media sign 100 is physically connected. Likewise, the betting limits area 112 is also reserved for information associated with the local casino game at hand. Other display areas, including the banner 108, borders, display attributes, and additional areas, such as message tickers, clocks, etc., can be common areas that are automatically updated by transmission of a current profile 208 edited at one media sign 100 and propagated to numerous media signs 100.

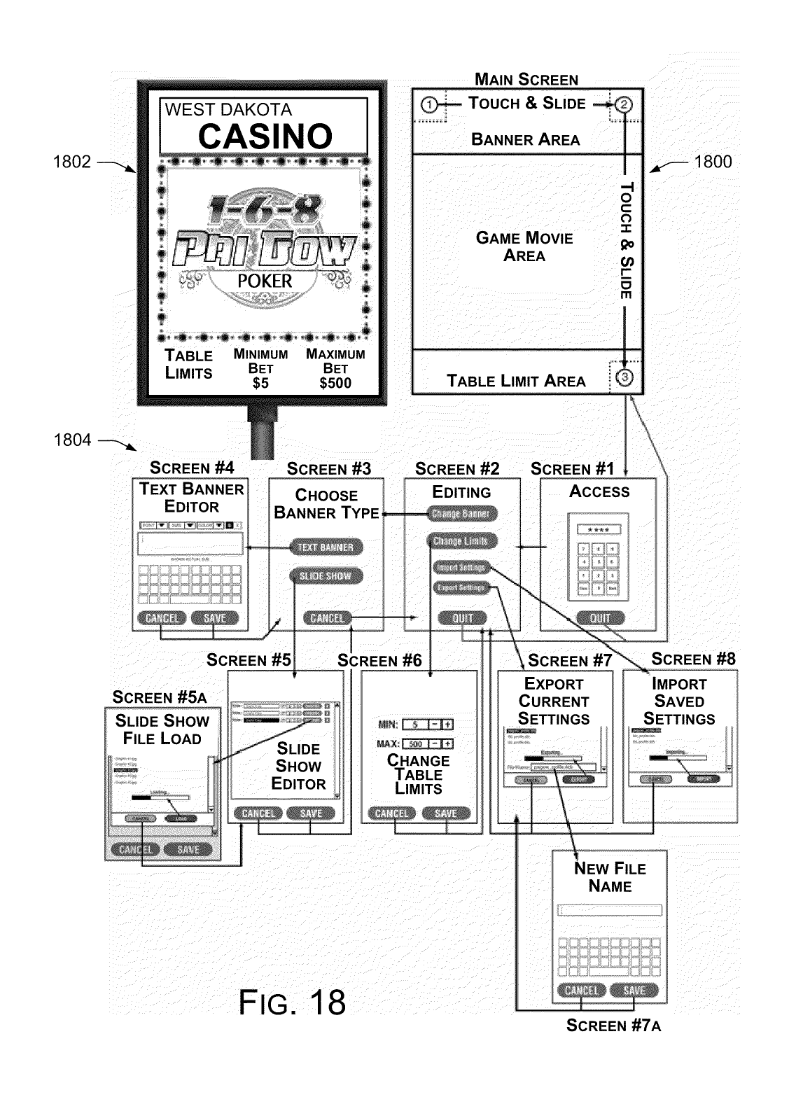

FIG. 18 shows an example display layout 1800 of the media sign; example display content 1802 of the media sign; and example logical links 1804 between an example hierarchy of GUI pages extended by the media sign. Other layouts, display content, logical links, and GUI pages are also contemplated within the scope of the subject matter described herein.

### CONCLUSION

Although exemplary systems have been described in language specific to structural features and/or methodological acts, it is to be understood that the subject matter defined in the appended claims is not necessarily limited to the specific features or acts described. Rather, the specific features and acts are disclosed as exemplary forms of implementing the claimed systems, methods, and structures.

1. A media sign for a casino game, comprising:
a touch screen display;
a controller for
managing images associated with the casino game, the images to be displayed on the touch screen display;
identifying touch gestures received by the touch screen display;
matching the identified touch gestures with display modes for the media sign and with editing functions for said managing the images;
extending at least one graphical user interface (GUI) for each editing function, each GUI for interacting with a user and receiving user input for the respective editing function.

2. The media sign as recited in claim 1, further comprising a computing device to host the controller and the touch screen display, wherein the controller comprises hardware and software components running on the computing device.

3. The media sign as recited in claim 1, wherein at least some of a displayable content for the media sign is programmable via a GUI revealed on a display surface of the media sign by a touch gesture on the display surface.

4. The media sign as recited in claim 1, wherein the controller further includes a security manager to extend a password prompt for authenticating a user before allowing the user access to the editing functions.

5. The media sign as recited in claim 1, wherein the controller further includes a game/movie pane editor to extend at least one GUI for editing displayable content associated with a game/movie pane area of the touch screen display; and
wherein the game/movie pane displays information associated with the casino game being played.

6. The media sign as recited in claim 1, wherein the controller further includes a betting limits editor to extend at least one GUI for editing displayable content associated with betting limit, including minimum bet and maximum bet, for the casino game being played.

7. The media sign as recited in claim 1, wherein the controller further includes a banner editor to extend at least one GUI for editing displayable content associated with a banner; and
wherein the banner displays information regarding a casino or establishment hosting the casino game.

8. The media sign as recited in claim, 7 wherein the banner editor includes a selector to choose between a text banner and a slideshow banner;
wherein the banner editor enables selection of at least text, font, style, and color for the text banner; and
wherein the banner editor enables selection and import of images for the slideshow banner.

9. The media sign as recited in claim 1, wherein the controller extends at least one GUI for importing displayable content and settings for the media sign and for exporting current displayable content and settings of the media sign; and
wherein the settings include displayable content and/or display parameters for a text banner pane of the media sign, for a game/movie pane of the media sign, and for a betting limits pane of the media sign.

10. The media sign as recited in claim 9, further comprising a port to import and export the displayable content and the settings; and
wherein the port comprises one of a universal serial bus (USB) port or an Ethernet port.

11. The media sign as recited in claim 10, further comprising an import manager to receive displayable content and settings from an external source and automatically reconfigure the media sign with the imported displayable content and the imported settings.

12. The media sign as recited in claim 10, further comprising an export manager to send displayable content and settings from the media sign to one or more other instances of the media sign via one of a portable data storage drive or a connected network; and
wherein the displayable content and settings sent from the export manager automatically reconfigure the one or more other instances of the media sign.

13. The media sign as recited in claim 1, wherein said images associated with a casino game include images associated with a casino, an establishment hosting the casino game, or an advertisement; and
wherein the images comprise one of a graphic, a text, a digital photograph, a game logo, a custom logo, an animation, a video clip, a video frame, a video stream, a television feed, or a real time message.

14. The media sign as recited in claim 1, wherein the controller further comprises an electronic game interface; and
wherein the media sign interacts with an electronic game hosting the casino game via the electronic game interface.

15. The media sign as recited in claim 14, wherein the controller causes the media sign to display one of a current state of the casino game, a summary of the casino game, casino game odds, a real time representation of play of the casino game, a card hand of the casino game, players of the casino game, a jackpot of the casino game, or a progressive jackpot meter.

16. A computer-executable method, comprising:
displaying casino game information on a touch screen display;
identifying a touch gesture on the touch screen display for initiating a first graphical user interface (GUI) for securing entry into a programming mode for the touch screen display;
upon successful authentication of a user via the first GUI, extending a second GUI for displaying a menu of editing modes for editing the casino game information.

17. The computer-executable method as recited in claim 16, wherein selection of a banner editing mode via the second GUI extends a third GUI for selecting between a text banner editing mode and a slideshow banner editing mode; and
wherein a banner comprises a pane of the touch screen display that displays casino information as one of a graphic, a text, a digital photograph, a logo, a custom logo, an animation, a video clip, a video frame, a video stream, a television feed, or a real time message.

18. The computer-executable method as recited in claim 16, wherein selection of a game/movie area editing mode via the second GUI extends a fourth GUI for editing displayable content associated with a game/movie area; and
wherein a game/movie area comprises a pane of the touch screen display that displays game information as one of a graphic, a text, a digital photograph, a game logo, a custom logo, an animation, a video clip, a video frame, a video stream, a television feed, or a real time message.

19. The computer-executable method as recited in claim 18, further comprising receiving information from real time play of an electronic game; and
displaying the information in real time in the game/movie area.

20. The computer-executable method as recited in claim 16, wherein selection of a betting limits editing mode via the second GUI extends a fifth GUI for editing displayable content associated with minimum and maximum betting limits for a casino game; and
wherein a betting limits area comprises a pane of the touch screen display that displays the minimum and maximum betting limits as one of a graphic, a text, a digital photograph, a game logo, a custom logo, an animation, a video clip, a video frame, a video stream, a television feed, or a real time message.

21. The computer-executable method as recited in claim 16, further comprising extending a sixth GUI for one of:
importing displayable content and associated settings for programming the touch screen display; or
exporting displayable content and associated settings to program one or more other instances of the touch screen display.

22. The computer-executable method as recited in claim 21, further comprising:
editing a current profile of displayable content and associated settings for the touch screen display; and
communicating the current profile over a network to multiple instances of the touch screen display to simultaneously update corresponding current profiles of the multiple instances of the touch screen display.
